(19) United States
(12) Patent Application Publication
(10) Pub. No.: US 2010/0172459 A1
(43) Pub. Date: Jul. 8, 2010

(54) FAST REACTOR

(75) Inventors: Takanari INATOMI, Kanagawa (JP); Toshiyuki Suzuki, Tokyo (JP); Hiroshi Nakamura, Kanagawa (JP)

Correspondence Address: FOLEY AND LARDNER LLP;SUITE 500, 3000 K STREET NW, WASHINGTON, DC, 20007, US

(73) Assignee: KABUSHIKI KAISHA TOSHIBA

(21) Appl. No.: 12/724,973

(22) Filed: Mar. 16, 2010

Related U.S. Application Data
(63) Continuation-in-part of application No. PCT/JP2008/002578, filed on Sep. 18, 2008.

(30) Foreign Application Priority Data
Sep. 20, 2007 (JP) 2007-244257

(51) Int. Cl. G21C 11/08; G21C 1/02; G21C 11/06

(52) U.S. Cl. 376/290

(57) ABSTRACT

A fast reactor has: a reactor vessel containing a coolant; a reactor core housed in the reactor vessel; a core supporting plate; a reflector; a partition arranged to surround the reflector on the side of the reactor vessel, for forming a passage of the coolant; a thermal shield arranged to cover at least one of the core side and the reactor vessel side of the partition; and a neutron shield. The thermal shield is mounted on the partition. The thermal shield includes a metallic thermal shield plate and a heat insulator mounted in the thermal shield plate, and has its inside filled with an inert gas. By the thermal shield, the thermal insulation of the partition can be improved to suppress the heat exchange between primary coolants on the core side and on the side of the reactor vessel of the partition.

### CROSS REFERENCE TO RELATED APPLICATIONS

This application is a continuation-in-part (CIP) application based upon the International Application PCT/JP2008/002578, the International Filing Date of which is Sep. 18, 2008, the entire content of which is incorporated herein by reference, and claims the benefit of priority from the prior Japanese Patent Application No. 2007-244257, filed in the Japanese Patent Office on Sep. 20, 2007, the entire content of which is incorporated herein by reference.

### BACKGROUND ART

The present invention relates to a fast reactor and, more particularly, to a fast reactor provided with a partition with high thermal insulation between the high and low temperature regions of primary coolant so as to improve reliability.

A conventional small-type fast reactor has a configuration in which a reactor core is surrounded by a plurality of vessels and a reflector is provided outside the vessels. Neutrons emitted from the reactor core to the outside are reflected by the reflector to thereby promote burnup of the reactor core.

However, in the fast reactor having such a configuration, the reflector is provided outside the reactor vessel, so that a vast amount of heat is dissipated in a structure housing the fast reactor by the reactor vessel and the reflector. Further, there is provided no neutron shield inside the reactor vessels, so that a large amount of neutrons are emitted outside the reactor vessel to activate argon or nitrogen retained in the upper portion of a shield structure. As a result, there arise problems that large scale cooling facilities or high-security containment facilities are required and that a stainless steel cannot be used as a structural material due to increased emission of neutrons and the use amount of a relatively expensive chrome steel is increased.

As an apparatus for eliminating such problems, there is known a fast reactor having a configuration disclosed in, e.g., Japanese Patent No. 3,126,524, the entire content of which is incorporated herein by reference. This fast reactor will be described with reference to FIG. 11.

FIG. 11 is a vertical cross-sectional view showing the outline of a fast reactor disclosed in Japanese Patent No. 3,126,524. A fast reactor 101 has a reactor core 102 including fuel assemblies and is formed into substantially a circular cylinder shape. The outer periphery of the reactor core 102 is surrounded by a core tank 103. Outside the core tank 103, an annular reflector 104 is provided so as to surround the core tank 103. The reflector 104 is connected to a reflector driver 112 through reflector drive shafts 111 and is driven upward and downward by the reflector driver 112. Outside the reflector 104, a partition 106 constituting the inner wall of a passage for primary coolant is provided so as to surround the reflector 104. Outside the partition 106, a reactor vessel 107 constituting the outer wall of the coolant passage is provided at a predetermined distance from the partition 106. The reactor vessel 107 is protected by a guard vessel 109 provided thereoutside. Further, a neutron shield 108 is provided outside the partition 106 and inside the coolant passage so as to surround the reactor core 102. Above the neutron shield 108, an electromagnetic pump 114, an intermediate heat exchanger 115, and a decay heat removal coil 116 are provided in order from the bottom. The intermediate heat exchanger 115 exchanges heat between secondary coolant flowing from a secondary coolant inlet nozzle 118 and primary coolant in the reactor vessel 107, and discharges the secondary coolant to a secondary coolant outlet nozzle 119. The reactor core 102, the core tank 103, the partition 106, and the neutron shield 108 are supported by a core support plate 113. An upper plug 110 is provided above the reactor vessel 107 so as to support the reflector driver 112.

According to the fast reactor 101 having the above configuration, the following effects can be obtained: the neutrons are effectively reflected by the reflector 104 disposed closely to the outer periphery of the reactor core 102 and the burnup and the breeding of the nuclear fuel can be hence effectively performed; the heat generated by the reflector 104 is utilized as a power of the fast reactor, thus improving the heat efficiency of the reactor; and the amount of neutrons emitted to the reactor vessel 107 or outside the reactor vessel 107 is decreased.

In the case where sodium is used as the coolant in the above fast reactor, the temperature of the coolant is assumed to be about 350° C. to 500° C. More specifically, a range (hereinafter, referred to as “high temperature region”) from the outlet of the reactor core to the inlet of the intermediate heat exchanger has a temperature of about 500° C., and a range (hereinafter, referred to as “low temperature region”) from the outlet of the intermediate heat exchanger to the inlet of the reactor core has a temperature of about 350° C. That is, the partition is operated in an environment where a temperature difference between the inner and outer peripheral sides thereof is excessive.

When heat is exchanged between the coolant in the high temperature region and the coolant in the low temperature region, a temperature drop between the inlet and the outlet of the intermediate heat exchanger is decreased to decrease power generation efficiency. Further, an increase in the temperature of the coolant in the low temperature region causes the temperature of the electromagnetic pump provided below the intermediate heat exchanger to rise, which is unfavorable in terms of the safety and efficiency of the electromagnetic pump. Further, there exist the reactor vessel, neutron shield, and core support plate in the low temperature region continued to the reactor core inlet, and the temperature rise of the coolant in the low temperature region may exert unfavorable influence in terms of the strength of these structures.

### BRIEF SUMMARY OF THE INVENTION

The present invention has been made in view of the above situation, and an object thereof is to provide a fast reactor with higher reliability than conventional ones, which is capable of enhancing thermal insulation performance of the partition so as to prevent decrease in power generation efficiency.

According to the present invention, there is presented a fast reactor comprising: a reactor vessel in which coolant is housed; a reactor core which is housed in the reactor vessel and which includes a fuel assembly; a core support plate which is fitted in the reactor vessel so as to support the reactor core; a reflector which surrounds the outer periphery of the reactor core and which can be moved in vertical direction; a partition which surrounds the reflector from the reactor vessel side thereof so as to form a flow channel of the coolant; a thermal shield which surrounds the partition from the reactor core side of the partition and/or the reactor vessel side thereof; a neutron shield which is provided in the flow channel of the coolant so as to surround the partition from the reactor vessel side thereof; an upper support plate which is fitted to the reactor vessel so as to support the reactor core, the partition, and the neutron shield; an intermediate heat exchanger which is set above the upper support plate; a pump which is provided in the flow channel of the coolant so as to drive the coolant; and an upper plug which is set in an upper part or above the reactor vessel and which includes a neutron shield layer and a thermal shield layer.

### BRIEF DESCRIPTION OF THE DRAWINGS

The above and other features and advantages of the present invention will become apparent from the discussion hereinbelow of specific, illustrative embodiments thereof presented in conjunction with the accompanying drawings, in which:

FIG. 1 is a vertical cross-sectional view showing the outline of a fast reactor according to a first embodiment of the present invention;

FIG. 2A is an enlarged vertical cross-sectional view showing a portion in the vicinity of the upper end of a thermal shield 40 according to the first embodiment;

FIG. 2B is an enlarged vertical cross-sectional view showing a portion in the vicinity of the lower end of the thermal shield 40 according to the first embodiment;

FIG. 3A is an enlarged vertical cross-sectional view showing an example of a heat expansion absorbing means according to the first embodiment;

FIG. 3B is an enlarged vertical cross-sectional view showing another example of the heat expansion absorbing means according to the first embodiment;

FIG. 4A is an enlarged vertical cross-sectional view showing a portion in the vicinity of the upper end of the thermal shield 40 according to a second embodiment of the present invention;

FIG. 4B is an enlarged vertical cross-sectional view showing a portion in the vicinity of the lower end of the thermal shield 40 according to the second embodiment;

FIG. 5 is an enlarged vertical cross-sectional view showing the area between the upper plug and thermal shield of the fast reactor according to a third embodiment of the present invention;

FIG. 6 is a vertical cross-sectional view showing the outline of the fast reactor according to a fourth embodiment;

FIG. 7A is an enlarged vertical cross-sectional view showing a portion in the vicinity of the upper end of the thermal shield 40 according to the fourth embodiment;

FIG. 7B is an enlarged vertical cross-sectional view showing a portion in the vicinity of the intermediate portion of the thermal shield 40 according to the fourth embodiment;

FIG. 7C is an enlarged vertical cross-sectional view showing a portion in the vicinity of the lower end of the thermal shield 40 according to the fourth embodiment;

FIG. 8 is a vertical cross-sectional view showing the outline of the fast reactor according to a fifth embodiment of the present invention;

FIG. 9A is an enlarged vertical cross-sectional view showing a portion in the vicinity of the upper end of the thermal shield 40 according to the fifth embodiment;

FIG. 9B is an enlarged vertical cross-sectional view showing a portion in the vicinity of the intermediate portion of the thermal shield 40 according to the fifth embodiment;

FIG. 9C is an enlarged vertical cross-sectional view showing a portion in the vicinity of the lower end of the thermal shield 40 according to the fifth embodiment;

FIG. 10A is an enlarged vertical cross-sectional view showing a portion in the vicinity of the upper end of the thermal shield 40 according to a sixth embodiment;

FIG. 10B is an enlarged vertical cross-sectional view showing a portion in the vicinity of the intermediate portion of the thermal shield 40 according to the sixth embodiment;

FIG. 10C is an enlarged vertical cross-sectional view showing a portion in the vicinity of the lower end of the thermal shield 40 according to the sixth embodiment; and

FIG. 11 is a vertical cross-sectional view showing the outline of a conventional reactor.

### DETAILED DESCRIPTION OF THE INVENTION

Embodiments of the present invention will be described below with reference to the accompanying drawings.

### First Embodiment

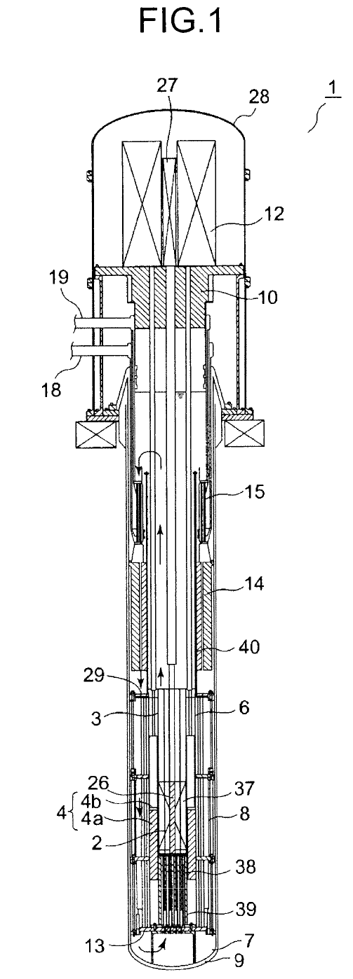

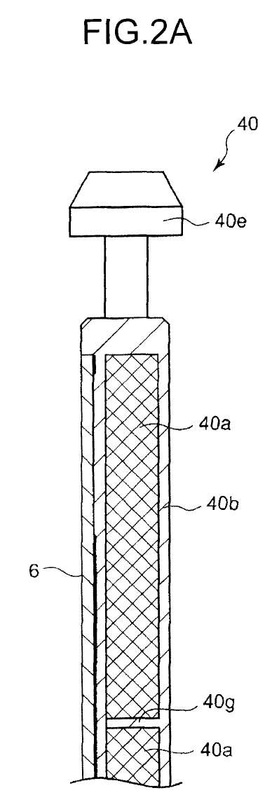

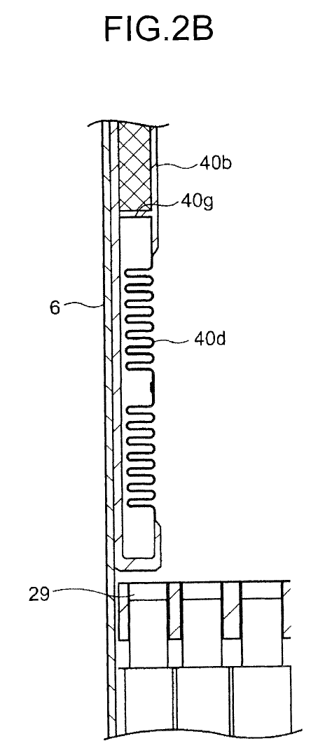

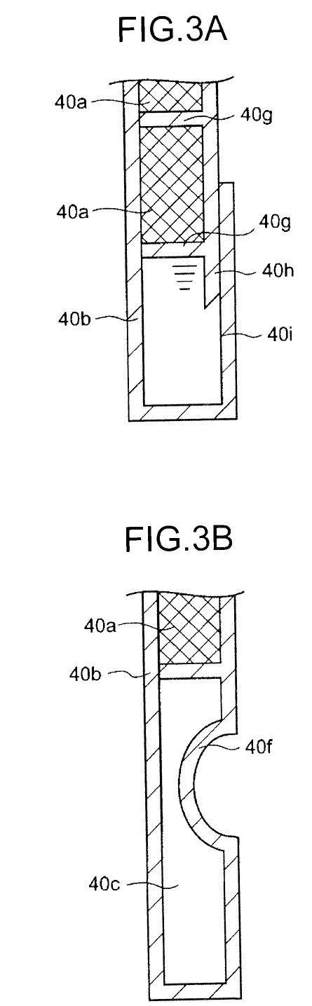

A first embodiment of the present invention will be described below with reference to FIGS. 1, 2A, 2B, 3A and 3B. FIG. 1 is a vertical cross-sectional view showing a configuration of a fast reactor according to the first embodiment of the present invention. FIG. 2A is an enlarged view of a portion in the vicinity of the upper end of a thermal shield 40 of the fast reactor 1 of FIG. 1, and FIG. 2B is an enlarged view of a portion in the vicinity of the lower end of the thermal shield 40. FIGS. 3A and 3B are each a cross-sectional view showing an example of a heat expansion absorbing means provided in the thermal shield 40.

A structure of the fast reactor 1 will be described below using FIG. 1. A core support plate 13 is fitted to the lower portion of a reactor vessel 7 surrounded by a guard vessel 9, and a core support base 39 is set on the core support plate 13. An entrance module 38 is set on the core support base 39. A plurality of fuel assemblies 37 are fitted to the entrance module 38 and constitute a reactor core 2. A safety rod 26 is inserted through the inside of the reactor core 2 and is connected to a safety rod driver 27 provided at the upper portion of the fast reactor 1. The outer periphery of the reactor core 2 is surrounded by a core tank 3 fitted to the upper surface of the core support plate 13. A reflector 4 is provided so as to surround the core tank 3. The reflector 4 is constituted by a neutron reflecting section 4a and a hollow cavity section 4b and is moved upward and downward by a reflector driver 12 provided at the upper portion of the fast reactor 1. Inactive gas or metal having a lower neutron reflecting capability than the coolant is encapsulated in the hollow cavity section 4b.

A partition 6 is fitted to the upper surface of the core support plate 13 so as to surround the reflector 4. The intermediate portion of the partition 6 is supported by an upper support plate 29 attached to the reactor vessel 7. The partition 6 is not fixed to the upper support plate 29 but is freely slid with respect to the upper support plate 29 when being extended or retracted in the vertical direction due to heat expansion. Further, a thermal shield 40 is provided on the reactor vessel 7 side of the partition 6. A neutron shield 8 is provided on the core support plate 13 so as to surround the outside of the partition 6.

An intermediate heat exchanger 15 is provided above the upper support plate 29 in the reactor vessel 7. The intermediate heat exchanger 15 has a secondary coolant inlet nozzle 18 and a secondary coolant outlet nozzle 19 and exchanges, inside the reactor vessel 7, heat between primary coolant in the reactor vessel 7 and secondary coolant. An electromagnetic pump 14 is attached to the lower portion of the intermediate heat exchanger 15 and feeds downward the primary coolant that has been subjected to heat exchange in the intermediate heat exchanger 15.

An upper plug 10 having a neutron shield layer and a thermal shield layer is provided in the upper part of the reactor vessel 7. The upper plug 10 supports the reflector driver 12 and the safety rod driver 27, and a containment dome 28 is provided so as to contain the reflector driver 12 and the safety rod driver 27. Further, primary coolant 21 is injected into the reactor vessel 7. The direction in which the primary coolant 21 flows is denoted by arrows in FIG. 1.

The flow of the primary coolant 21 will be described in detail. The primary coolant 21 is heated in the reactor core 2 and rises up. The primary coolant 21 then passes above the partition 6 and the thermal shield 40 and flows into the intermediate heat exchanger 15. In the intermediate heat exchanger 15, the primary coolant 21 is subjected to heat exchange with the secondary coolant to be cooled and discharged below the electromagnetic pump 14 by means of the electromagnetic pump 14 provided under the intermediate heat exchanger 15. The primary coolant 21 discharged from the electromagnetic pump 14 further flows down, passes through the upper support plate 29 and core support plate 13, and reaches the bottom of the reactor vessel 7. After that, the primary coolant 21 passes through the core support plate 13, core support base 39, and entrance module 38 and flows into the reactor core 2 once again. The primary coolant 21 is circulated repeatedly as described above. In the case where sodium is used as the primary coolant, the temperature of the primary coolant 21 is about 500 ° C. after passage through the reactor core 2 and is about 350° C. after passage through the intermediate heat exchanger 15.

A structure of the thermal shield 40 will be described in detail using FIGS. 2A, 2B and 2C.

As shown in FIG. 2A, the thermal shield 40 is mounted so as to be suspended from the upper end of the partition 6. The thermal shield 40 is constituted by a hollow metal thermal shield plate 40b, partitions 40g partitioning the internal space of the thermal shield plate 40b, heat insulators 40a provided in the space partitioned by the partitions 40g and internally encapsulated inactive gas 40c. The partitions 40g are not formed integrally with the inner wall on the partition 6 side in the thermal shield plate 40b but can be slid in accordance with a heat expansion difference between the upper and lower portions of the partitions 40g which is caused by a temperature difference between inner and outer peripheral sides. Examples of the heat insulator 40a materials include, e.g., zirconia ceramics, silicon carbide ceramics, silicon nitride ceramics, alumina ceramics, fiberglass, ceramic fiber, glass wool, rock wool and ceramic wool. Examples of the inactive gas 40c include helium, argon and neon.

A joint 40e is formed at the upper end portion of the thermal shield 40. When the partition 6 and the thermal shield 40 need to be inspected or repaired, it is possible to take out the thermal shield 40 by removing upper structures such as the upper plug 10, lowering a crane or jig from above of the fast reactor 1, and connecting the crane or jig to the joint 40e by remote control. Further, in the case of the joint 40e having a shape as shown in the drawing, it is possible to press down the thermal shield 40 from above, allowing the joint 40e to be utilized when the thermal shield 40 is installed in the reactor vessel 7.

As shown in FIG. 2B, bellows 40d are provided at the lower portion of the thermal shield plate 40b. The internal space of the bellows 40d communicates with a space where the heat insulator 40a is provided through a clearance between the thermal shield plate 40b and the partitions 40g. The inactive gas 40c is also encapsulated in the bellows 40d. The bellows 40d function as heat expansion absorbing means for absorbing an extension difference of the thermal shield plate 40b in the vertical direction due to heat expansion caused by a temperature difference between the reactor core side and the reactor vessel side thereof.

In place of the bellows 40d, a sliding structure shown in FIG. 3A or an omega seal 40f shown in FIG. 3B may be provided as the heat expansion absorbing means.

In the sliding structure shown in FIG. 3A, the lower end of the thermal shield plate 40b is formed in a pocket-like shape. A reactor vessel 7 side lower end portion 40h of the thermal shield plate 40b is slid in the vertical direction in the pocket, whereby the extension difference due to heat expansion is absorbed. In this structure, an internal space 40i of the thermal shield plate 40b is not sealed, allowing the primary coolant 21 to enter the inside of the thermal shield plate 40b.

In the structure shown in FIG. 3B, the omega seal 40f is expanded and contracted in accordance with the extension and retraction of the thermal shield plate 40b, whereby the extension difference due to heat expansion is absorbed. Although the heat expansion absorbing means is provided at the lower portion of the thermal shield 40 in FIG. 1, the heat expansion absorbing means may be provided at the upper portion or intermediate portion of the thermal shield 40.

Although the thermal shield 40 is provided on the reactor vessel 7 side of the partition 6 in the present embodiment, the thermal shield 40 may be alternatively provided on the reactor core 2 side of the partition 6.

According to the fast reactor 1 of the present embodiment, it is possible to enhance thermal insulation performance by fitting the thermal shield 40 to the partition 6 and prevent heat exchange between the primary coolant 21 that has been heated by the reactor core 2 and the primary coolant 21 discharged from the electromagnetic pump 14 through the partition 6, thereby preventing decrease in power generation efficiency. Further, the use of the joint 40e formed at the upper portion of the thermal shield 40 makes it easy to take out the thermal shield 40 from the reactor, thereby obtaining excellent maintainability and repairability.

The partition 6 may be divided into two in the vertical direction by the upper support plate 29 and, in this case, the upper side of the partition 6 can be fixed on the upper support plate 29. Thus, by dividing the partition 6 into upper and lower portions by the upper support plate 29, the size of the partition 6 having an elongated structure is reduced to improve manufacturability. The thermal shield 40 extends from the upper end of the partition 6 to the upper support plate 29, so that even when the partition 6 is divided in two in the vertical direction, the same effect can be obtained.

### Second Embodiment

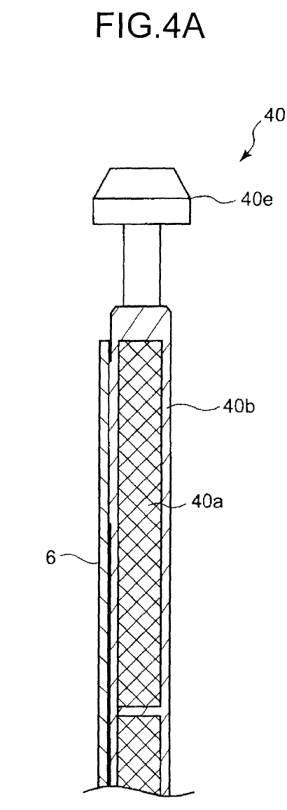

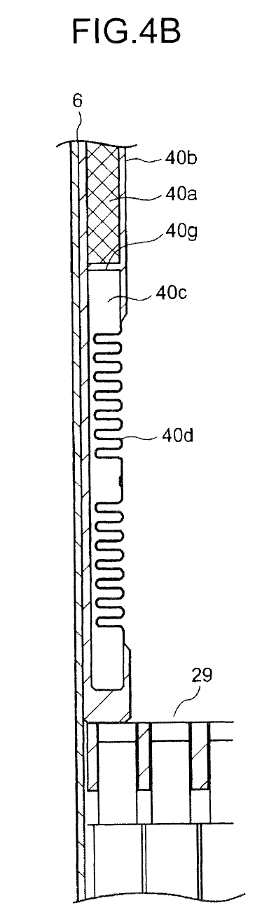

A second embodiment of the present invention will be described below with reference to FIGS. 4A and 4B. FIG. 4A is an enlarged view of the upper portion of the thermal shield 40 according to the present embodiment, and FIG. 4B is an enlarged view of the lower portion of the thermal shield 40 according to the present embodiment. The same reference numerals are given to the same or similar configurations as those in the first embodiment, and a duplicate description thereof is omitted.

As shown in FIG. 4B, in the fast reactor 1 according to the present embodiment, the thermal shield 40 is not suspended from the partition 6, but is configured to stand alone on the upper surface of the upper support plate 29.

According to the present embodiment, the thermal shield 40 is arranged independently, so that a load of the thermal shield 40 is not applied to the partition 6, thereby reducing a load on the partition 6. Since the thermal shield 40 is fixed only to the upper support plate 29, heat expansion thereof in the vertical direction is not constrained.

As described above, according to the present embodiment, a load on the partition 6 can be reduced.

### Third Embodiment

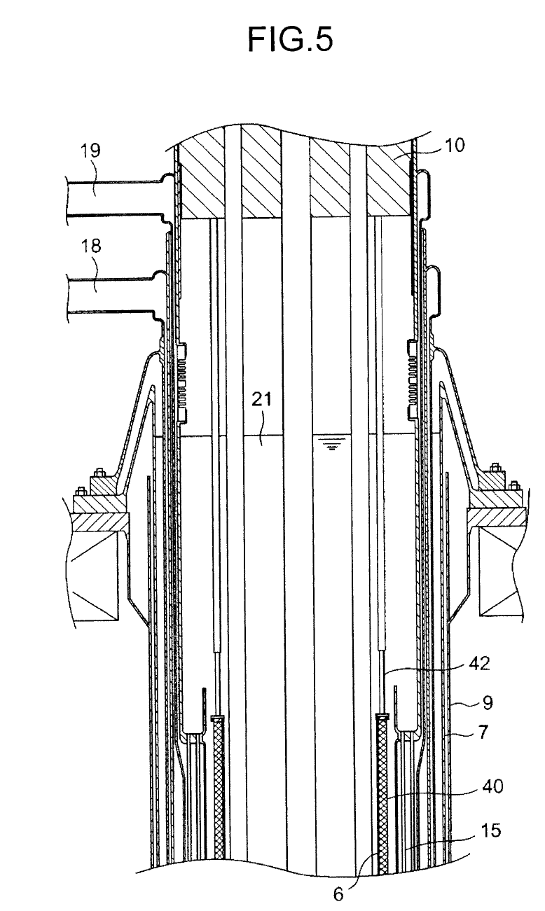

A third embodiment of the present embodiment will be described with reference to FIG. 5. FIG. 5 is an enlarged cross-sectional view of an area from the upper portions of the partition 6 and thermal shield 40 of the fast reactor 1 to the upper plug 10. The same reference numerals are given to the same or similar configurations as those in the first and second embodiments, and a duplicate description thereof is omitted.

As shown in FIG. 5, thermal shield support rods 42 fitted to the upper plug 10 support the upper end of the thermal shield 40. By adopting the configuration in which the thermal shield support rods 42 support the thermal shield 40 by pressing the upper end thereof from above as described above, the positional stability of the thermal shield 40 can be enhanced. Further, the thermal shield support rods 42 function as heat expansion absorbing means and can absorb a heat expansion difference generated between the lower end of the upper plug and the upper end of the partition 6, preventing an excessive load from being applied to the thermal shield 40 and the partition 6 during operation.

The above support structure may be applied not only to the configuration as shown in FIG. 5 in which the thermal shield 40 is suspended from the upper end of the partition 6, but also to a configuration as shown in the second embodiment in which the partition 6 and the thermal shield 40 are separated from each other. Further, the use of the thermal shield support rods 42 makes it easy to take out the thermal shield 40 from the reactor.

### Fourth Embodiment

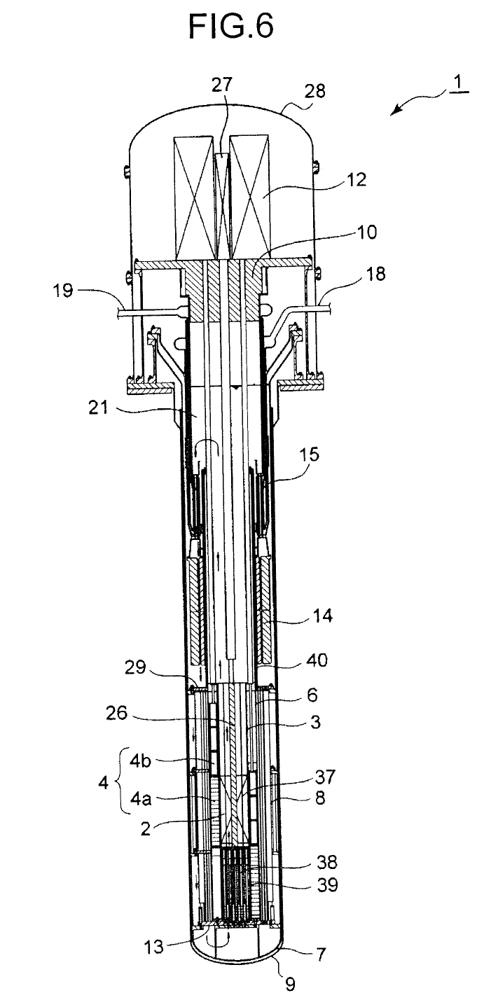

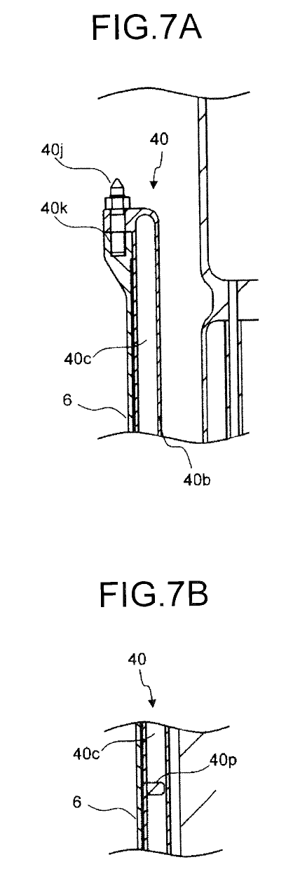

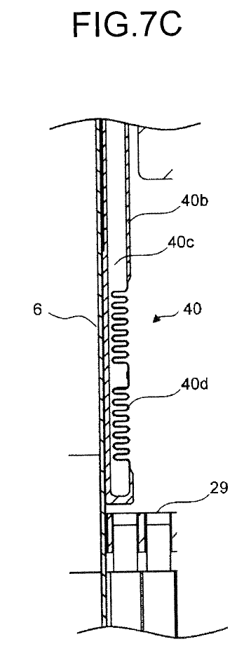

A fourth embodiment of the present invention will be described below with reference to FIGS. 6, 7A, 7B and 7C. FIG. 6 is a vertical cross-sectional view showing a configuration of the fast reactor according to the fourth embodiment. FIG. 7A is an enlarged view of a portion in the vicinity of the upper end of the thermal shield 40 of the fast reactor 1 of FIG. 6, FIG. 7B is an enlarged view of a portion in the vicinity of the intermediate portion of the thermal shield 40, and FIG. 7C is an enlarged view of a portion in the vicinity of the lower end of the thermal shield 40. The same reference numerals are given to the same or similar configurations as those in the first embodiment, and a duplicate description thereof is omitted.

As shown in FIG. 7A, in the present embodiment, the thermal shield 40 is suspended from the upper end of the partition 6. Further, as shown in FIG. 7B, the thermal shield 40 includes the hollow thermal shield plate 40b and a pad 40p for retaining the internal space of the thermal shield plate 40b. The inactive gas 40c is encapsulated in the internal space surrounded by the thermal shield plate 40b. A gap between the inside (reactor core side) of the thermal shield 40 and outside (pressure vessel wall side) thereof is retained by the pad 40p, thereby preventing the inside and outside from contacting each other. The pad 40p is not formed integrally with the inner wall on the opposite side to the partition 6 in the thermal shield plate 40b but can be slid in accordance with a heat expansion difference between the upper and lower portions of the pad 40p which is caused by a temperature difference between inner and outer peripheral sides. Preferable examples of the inactive gas 40c include helium, argon and neon.

Further, a fastening portion 40k is formed at the upper end of the thermal shield 40, and the thermal shield 40 is fixed to the upper end of the partition 6 by a fastening member 40j. The fastening member 40j can retain the thermal shield 40 against vertical acceleration induced by an earthquake. When the partition 6 and the thermal shield 40 need to be inspected or repaired, it is possible to take out the thermal shield 40 by removing upper structures such as the upper plug 10, lowering a crane or jig from above of the fast reactor 1, removing the fastening member 40j by remote control, and connecting the jig or the like to the fastening portion 40k.

As shown in FIG. 7C, the bellows 40d are provided at the lower portion of the thermal shield plate 40b. The inactive gas 40c is encapsulated in the internal space of the bellows 40d. The bellows 40d function as heat expansion absorbing means for absorbing an extension difference of the thermal shield plate 40b in the vertical direction due to heat expansion caused by a temperature difference between the reactor core side and reactor vessel side thereof.

Although the thermal shield 40 is provided on the reactor vessel 7 side of the partition 6 in the present embodiment, the thermal shield 40 may be alternatively provided on the reactor core 2 side of the partition 6.

According to the fast reactor 1 of the present embodiment, it is possible to obtain the same effect as that obtained in the first embodiment and to stably retain the thermal shield 40 even when vertical acceleration is applied thereto by an earthquake. Further, by dividing the partition 6 into upper and lower portions by the upper support plate 29, the size of the partition 6 having an elongated structure is reduced to improve manufacturability. The thermal shield 40 extends from the upper end of the partition 6 to the upper support plate 29, so that even when the partition 6 is divided in two in the vertical direction, the same effect can be obtained.

As in the case of the first embodiment, the joint 40e (see FIG. 2A) may be fitted. Further, the configuration in which the thermal shield according to the fourth embodiment is fixed to the partition may be applied to the thermal shield of the first embodiment.

Although not described above, there are slight differences between the configurations of FIGS. 1 and 6. For example, in the configuration of FIG. 6, a left/right positional relationship between the secondary coolant inlet nozzle 18 and secondary coolant outlet nozzle 19 is reversed with respect to that in FIG. 1 and, further, a positional relationship between the neutron reflecting section 4a and the cavity section 4b is reversed between the left and right sides. However, the above differences are not related to the essence of the present invention and therefore it can be said that the configurations of FIGS. 1 and 6 are substantially the same.

### Fifth Embodiment

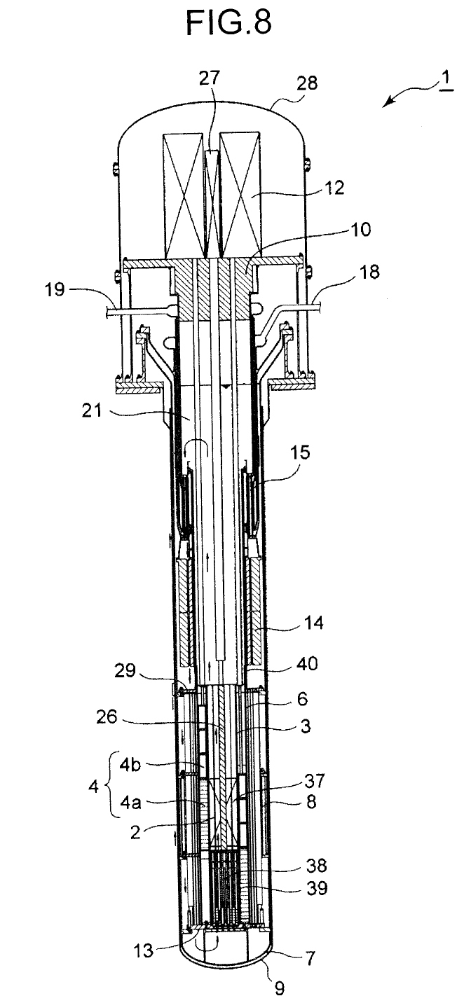

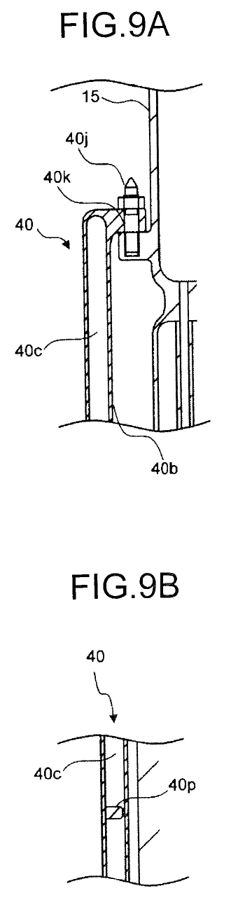

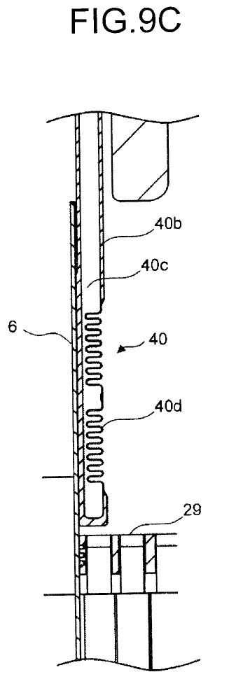

A fifth embodiment of the present invention will be described with reference to FIGS. 8, 9A, 9B and 9C. FIG. 8 is a vertical cross-sectional view showing a configuration of the fast reactor according to the fifth embodiment of the present invention. FIG. 9A is an enlarged view of the upper portion of the thermal shield 40 according to the present embodiment, FIG. 9B is an enlarged view of the intermediate portion of the thermal shield 40 according to the present embodiment, and FIG. 9C is an enlarged view of the lower portion of the thermal shield 40 according to the present embodiment. The same reference numerals are given to the same or similar configurations as those in the fourth embodiment, and a duplicate description thereof is omitted.

In the fast reactor 1 according to the present embodiment, as shown in FIG. 9A, the thermal shield 40 is suspended not from the partition 6 but from the upper portion of the intermediate heat exchanger 15.

According to the present embodiment, the configuration in which the thermal shield 40 is suspended from the intermediate heat exchanger 15 prevents a load of the thermal shield 40 from being applied to the partition 6 existing in a high temperature environment, reducing a load on the partition 6. Further, the thermal shield 40 need not be suspended from the upper end of the partition 6, so that the length of the partition 6 can be shortened so as to improve manufacturability of the partition 6.

Further, both side surfaces of the thermal shield 40 are exposed in this configuration, making it much easier to perform repair and maintenance of the thermal shield. In the case where the length of the partition 6 is shortened as described above, the thermal shield 40 constitutes a part of the flow channel of the primary coolant.

Further, the configuration of the fifth embodiment in which the thermal shield is fixed to the intermediate heat exchanger may be applied to the thermal shield of the first embodiment.

### Sixth Embodiment

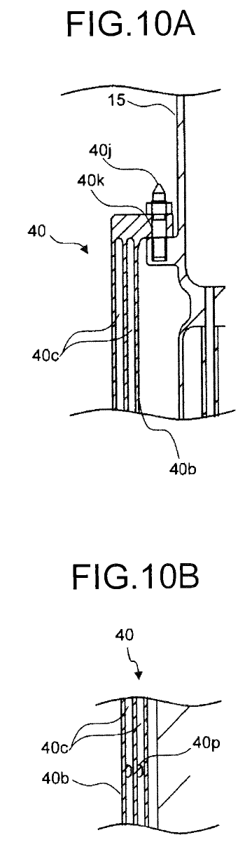

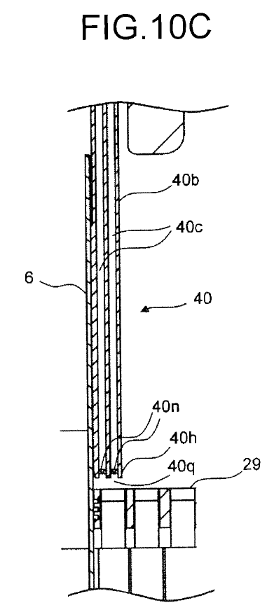

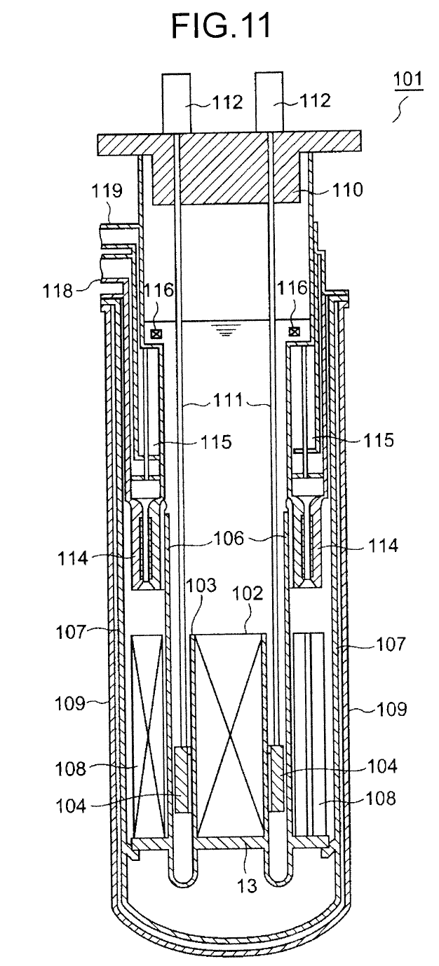

A sixth embodiment of the present invention will be described below with reference to FIGS. 10A, 10B and 10C. FIGS. 10A, 10B and 10C are vertical cross-sectional views each showing a configuration of the fast reactor according to the sixth embodiment of the present invention. FIG. 10A is an enlarged view of the upper portion of the thermal shield 40 according to the present embodiment, FIG. 10B is an enlarged view of the intermediate portion of the thermal shield 40 according to the present embodiment, and FIG. 10C is an enlarged view of the lower portion of the thermal shield 40 according to the present embodiment. The same reference numerals are given to the same or similar configurations as those in the fourth or fifth embodiments, and a duplicate description thereof is omitted.

In the fast reactor 1 according to the present embodiment, as shown in FIG. 10A, the thermal shield 40 is suspended not from the partition 6 but from the upper portion of the intermediate heat exchanger 15 as in the fifth embodiment. Further, in this embodiment, the thermal shield 40 is constituted by the thermal shield plate 40b having a multilayer structure comprising. e.g., three layers in the radial direction of the fast reactor 1. An opening portion 40q that opens downward is formed in the vicinity of the lower end portion 40h.

The inside of the thermal shield 40 is filled with the inactive gas 40c. For example, the inside of the reactor vessel 7 is drawn vacuum and displaced with the inactive gas 40c before filling with the primary coolant 21, followed by the filling of the reactor vessel 7 with the primary coolant 21. Thus, the inside of the thermal shield 40 is filled with the inactive gas 40c. At this time, a coolant liquid level 40n is formed in the opening portion 40q. Although the coolant liquid level 40n varies depending on the differential pressure between the inactive gas 40c and the primary coolant 21 at the lower end portion 40h generated in accordance with the operating condition of the fast reactor 1, the coolant liquid level 40n is positioned almost in the vicinity of the lower end portion 40h. The pad 40p is attached to each of the thermal shield plates 40b as shown in FIG. 10B and is configured to be able to be slid in accordance with a heat expansion difference between the upper and lower portions of the pad 40p which is caused by a temperature difference between inner and outer peripheral sides.

According to the present embodiment, by constituting the thermal shield 40 by the thermal shield plate 40b having a multilayer structure, it is possible to form a plurality of separate gas spaces. Thus, even if any of the thermal shield plates 40b is damaged, the inactive gas 40c filled in the inside of the thermal shield 40 is not discharged into the reactor vessel 7 at a time. This ensures multiple safety to improve reliability of the thermal shield 40. Further, the structure can be made simple, thereby improving manufacturability and reducing cost.

Although the thermal shield 40 is suspended from the upper portion of the intermediate heat exchanger 15 in the configuration shown in FIGS. 10A, 10B and 10C as in the cases of the fifth embodiment, it is possible to adopt the configuration of the fourth embodiment in which the thermal shield 40 is suspended from the upper portion of the partition 6. Further, as shown in FIGS. 7C and 9C, it is possible to set the thermal shield plate 40b having a multilayer structure in the thermal shield 40 even in the thermal shield 40 in which the inactive gas 40c is encapsulated in the internal space of the bellows 40d. In this case, even if the bellows 40d have been broken, the coolant liquid level 40n is formed in the lower end portion 40h of the thermal shield 40 and performs the same thermal insulation function as in the present embodiment.

As described above, according to the present embodiment, it is possible to improve reliability and manufacturability of the thermal shield 40.

The configuration in which the heat expansion absorbing means of the sixth embodiment is made opened may be applied to the thermal shields according to the first to fourth embodiments.

Although the embodiments of the present invention have been described with reference to the accompanying drawings, it should be understood that the present invention is not limited to the above representative examples, but various modifications may be adopted, for example, by combining the first to sixth embodiments without departing from the scope of the present invention. Thus, various modifications and changes may be made to the concrete embodiments by those skilled in the art without departing from the technical concept and technical scope of the invention.

1. A fast reactor comprising:
a reactor vessel in which coolant is housed;
a reactor core which is housed in the reactor vessel and which includes a fuel assembly;
a core support plate which is fitted in the reactor vessel so as to support the reactor core;
a reflector which surrounds the outer periphery of the reactor core and which can be moved in vertical direction;
a partition which surrounds the reflector from the reactor vessel side thereof so as to form a flow channel of the coolant;
a thermal shield which surrounds the partition from the reactor core side of the partition and/or the reactor vessel side thereof;
a neutron shield which is provided in the flow channel of the coolant so as to surround the partition from the reactor vessel side thereof;
an upper support plate which is fitted to the reactor vessel so as to support the reactor core, the partition, and the neutron shield;
an intermediate heat exchanger which is set above the upper support plate;
a pump which is provided in the flow channel of the coolant so as to drive the coolant; and
an upper plug which is set in an upper part or above the reactor vessel and which includes a neutron shield layer and a thermal shield layer.

2. The fast reactor according to claim 1, wherein
the thermal shield includes a heat insulator and a thermal shield plate housing the heat insulator.

3. The fast reactor according to claim 1, wherein
the thermal shield includes a thermal shield plate having a hollow structure with a hollow portion which is filled with inactive gas.

4. The fast reactor according to claim 3, wherein
the hollow portion of the thermal shield plate has a plurality of layers in radial direction of the reactor vessel, and
each of the layers of the hollow portion is filled with inactive gas.

5. The fast reactor according to claim 1, wherein
the thermal shield includes heat expansion absorbing means.

6. The fast reactor according to claim 5, wherein
the heat expansion absorbing means includes one out of a group consisting of bellows, a sliding structure, and an opening portion opening downward with respect to the thermal shield.

7. The fast reactor according to claim 1, wherein
the thermal shield is suspended from upper portion of the partition.

8. The fast reactor according to claim 1, wherein
the thermal shield is provided so as to stand alone on the upper surface of the upper support plate.

9. The fast reactor according to claim 1, wherein
the thermal shield is fixed to the partition or the intermediate heat exchanger by a fastening member.

10. The fast reactor according to claim 1, comprising second heat expansion absorbing means which is fitted to the upper plug so as to support the upper end of the thermal shield.

11. The fast reactor according to claim 1, wherein
a joint is formed at the upper end of the thermal shield.
